(19) United States
(12) Patent Application Publication
(10) Pub. No.: US 2004/0038055 A1
(43) Pub. Date: Feb. 26, 2004

(54) Multi-layer, deep-drawable and sealable film

(76) Inventor: Joachim Hawighorst, Ibbenburen (DE)

Correspondence Address: WILLIAM COLLARD, COLLARD & ROE, P.C., 1077 NORTHERN BOULEVARD, ROSLYN, NY, 11576, US

(21) Appl. No.: 10/462,316

(22) Filed: Jun. 13, 2003

(30) Foreign Application Priority Data
Jun. 15, 2002 (DE) 102 26 805.3

(51) Int. Cl. B32B 27/08

(52) U.S. Cl. 428/475.8; 428/474.4

(57) ABSTRACT

A multi-layer, deep-drawable and sealable film, produced by means of blown film extrusion, having a layer thickness of less than 150 μm, has a layer structure A1/B/A2/C/D, wherein

A1 is a first polyamide layer,

B is an equalization layer,

A2 is a second polyamide layer,

C is a bonding agent layer, and

D is a sealing layer made from a polyolefin and polyolefin copolymer.

The equalization layer between the polyamide layers possesses a layer thickness that amounts to more than 25% of the film thickness and is greater than the sum of the two polyamide layers.

### CROSS REFERENCE TO RELATED APPLICATIONS

Applicant claims priority under 35 U.S.C. §119 of German Application No. 102 26 805.3 filed Jun. 15, 2002.

### BACKGROUND OF THE INVENTION

1. Field of the Invention

The invention relates to a multi-layer, deep-drawable and sealable film, the layer structure of which has an outside layer composed of polyamide and a sealing layer composed of a polyolefin or a polyolefin copolymer. Films produced by means of coextrusion, with layers composed of polyamide and a polyolefin, e.g. polyethylene (PE), are characterized by good deep-drawability, impact strength, and softness, as well as good optical properties of the polyamide surface, and are particularly suitable for deep-drawn packaging on the basis of these properties.

2. The Prior Art

DE 43 06 716 A1 describes a multi-layer, deep-drawable and sealable film having a layer structure consisting of polyamide, an intermediate layer of a polyethylene (PE) copolymer, polyamide, as well as a sealing layer of polyethylene. The films possess a relatively great thickness of more than 250 μm, and are supposed to demonstrate not only good deep-drawing properties but also a good resistance to cutting penetration.

U.S. Pat. No. 5,906,850 describes multi-layer films having the following layer structure: polyamide/bonding agent layer/polyamide/bonding agent layer/sealing layer composed of an ionomer. Ionomer refers to ionically cross-linked mixed polymerizates of ethylene, propylene, butylene, vinyl esters, and unsaturated aliphatic acids, their salts and their esters. The films described are suitable as so-called “cook-in films,” particularly for boiled pickled foods.

Films produced by means of blown film extrusion, having an outer polyamide layer and a sealing layer of polyethylene or a polyethylene copolymer, usually demonstrate a significant tendency to roll up, because of the different solidification behavior of the materials during blown film extrusion, and this makes further processing of the film difficult. The tendency to roll up is particularly marked in the case of thin blown films, which have a layer thickness of less than 150 μm, and includes a curvature of the film towards the polyolefin side. The behavior observed is based on the fact that the polyamide layer and the polyolefin layer solidify one after the other. When solidification of a polyolefin layer consisting of polyethylene, for example, starts, the polyamide layer has already solidified completely. Solidification of the polyethylene is connected with shrinkage, which results in curvature of the crystallized and solidified polyamide layer.

### SUMMARY OF THE INVENTION

The object of the invention is to reduce the tendency of a deep-drawable and sealable coextrusion film composed of polyamide and polyolefins, particularly of polyamide and polyethylene, to roll up.

These and other objects of the invention are achieved by a multi-layer, deep-drawable and sealable film, produced by means of blown film extrusion, having a layer thickness of less than 150 μm, and having a layer structure A/B/A/C/D, consisting of

A) polyamide,

B) an equalization layer,

A) polyamide,

C) a bonding agent layer, and

D) a sealing layer composed of a polyolefin and a polyolefin copolymer,

whereby the equalization layer between the polyamide layers possesses a layer thickness that amounts to more than 25% of the film thickness and is greater than the sum of the two polyamide layers. Preferably, the sealing layer consists of polyethylene or a polyethylene copolymer.

The film according to the invention has a relatively thick intermediate layer that splits the polyamide layer. In this way, a significant reduction in the tendency of the finished film to roll up can be achieved in surprisingly simple manner. In contrast, it is practical if the bonding agent layer, which connects the sealing layer with polyamide, demonstrates a low layer thickness in comparison with the adjacent layers.

The equalization layer, as a bonding agent, can consist of a polyolefin modified with anhydride or with acid, e.g. a polyethylene modified with anhydride or with acid, or a polyolefin copolymer having functional groups, particularly a polyethylene copolymer having functional groups. The equalization layer may also be structured in three layers and have a layer that is incompatible with polyamide, arranged between two bonding agent layers.

The polyamide layers can consist of aliphatic polyamides PA6, PA6.66, PA11, PA12, or a copolymer of the monomers contained in them, of a partially aromatic polyamide, or of a mixture of the stated polyamides.

A polyolefin copolymer having functional groups, or a polyolefin modified with anhydride or with acid, can be used as the bonding agent layer. A polyethylene copolymer having functional groups, or a polyethylene modified with anhydride or with acid, is preferred.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, which schematically show, in a greatly magnified representation, in each instance:

FIG. 1 shows the layer structure of a multi-layer film produced by means of blown film extrusion, according to an embodiment of the invention; and

FIG. 2 shows the layer structure of another embodiment of a film according to the invention.

### DETAILED DESCRIPTION OF PREFERRED EMBODIMENTS

The object of the invention is deep-drawable and sealable films, produced by means of blown film extrusion, having a layer thickness of less than 150 μm, which are suitable, among other things, for deep-drawn packaging. They possess a layer structure having the sequence A/B/A/C/D, consisting of

A) polyamide,

B) an equalization layer,

A) polyamide,

C) a bonding agent layer, and

D) a sealing layer composed of a polyolefin and a polyolefin copolymer, preferably of polyethylene or a polyethylene copolymer.

The equalization layer B between the polyamide layers A possesses a layer thickness that amounts to more than 25% of the film thickness and is greater than the sum of the two polyamide layers. Because of the asymmetrical distribution of the layer thicknesses, according to the invention, and particularly due to the use of the thick equalization layer B provided according to the invention, which splits the polyamide region of the film, a significant reduction in the tendency of the finished film to roll up can be achieved. In this connection, the bonding agent layer C, which connects the sealing layer with polyamide, is structured with a low layer thickness in comparison with the adjacent layers.

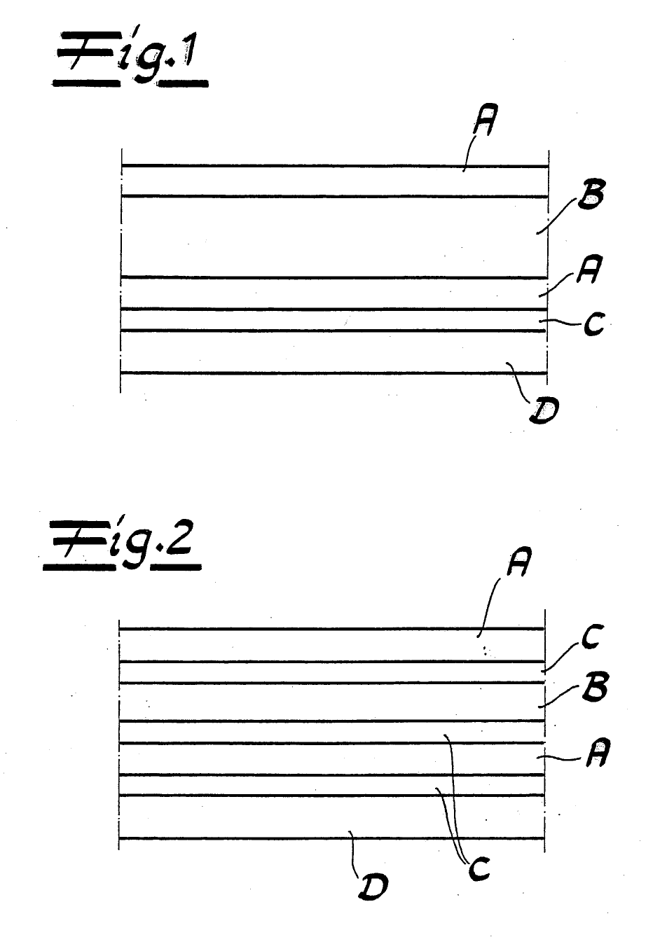

In the layer structure shown in FIG. 1, the equalization layer B as the bonding agent consists of a polyethylene modified with anhydride or with acid, or a polyethylene copolymer having functional groups. According to the layer structure shown in FIG. 2, the equalization layer B can also be structured in three layers and have a layer, e.g. composed of polypropylene, that is incompatible with polyamide, arranged between two bonding agent layers.

The polyamide layers consist of aliphatic polyamides PA6, PA6.66, PA11, PA12, or a copolymer of the monomers contained in them, of a partially aromatic polyamide, or of a mixture of the stated polyamides. Polyethylene copolymers having functional groups, or polyethylene modified with anhydride or acid, are suitable as bonding agent layers.

### EXAMPLE 1

The film possesses a total thickness of 70 μm and has a layer structure according to FIG. 1, with the following layer distribution:

A: 10 μm polyamide,

B: 30 μm equalization layer composed of polyethylene, a polyethylene copolymer, or a polyethylene modified with anhydride or with acid,

A: 10 μm polyamide,

C: 5 μm bonding agent composed of polyethylene, a polyethylene copolymer, or a polyethylene modified with anhydride or with acid,

D: 15 μm sealing layer composed of polyethylene or a polyethylene copolymer.

### EXAMPLE 2

The film also possesses a film thickness of 70 μm and has a layer structure according to FIG. 2, with the following layer distribution:

A: 10 μm polyamide,

C: 5 μm bonding agent composed of polyethylene, a polyethylene copolymer, or a polyethylene modified with anhydride or with acid,

B: 20 μm equalization layer composed of polypropylene,

C: 5 μm bonding agent composed of polyethylene, a polyethylene copolymer, or a polyethylene modified with anhydride or with acid,

A: 10 μm polyamide,

C: 5 μm bonding agent composed of polyethylene, a polyethylene copolymer, or a polyethylene modified with anhydride or with acid,

D: 15 μm sealing layer composed of polyethylene or a polyethylene copolymer.

### EXAMPLE 3

The film possesses a total thickness of 70 μm and has a layer structure according to FIG. 1, with the following layer distribution:

A: 10 μm polyamide,

B: 30 μm equalization layer composed of polypropylene, a polypropylene copolymer, or a polypropylene modified with anhydride or with acid,

A: 10 μm polyamide,

C: 5 μm bonding agent,

D: 15 μm sealing layer composed of polypropylene or a polypropylene copolymer.

While only a few embodiments of the present invention have been shown and described, it is to be understood that many changes and modifications may be made thereunto without departing from the spirit and scope of the invention as defined in the appended claims.

What is claimed is:

1. Multi-layer, deep-drawable and sealable film, produced by means of blown film extrusion, having a layer thickness of less than 150 μm, and comprising a layer structure A1/B/A2/C/D, wherein
A1 is a first polyamide layer,
B is an equalization layer,
A2 is a second polyamide layer,
C is a bonding agent layer, and
D is a sealing layer made from a polyolefin and a polyolefin copolymer,
wherein the equalization layer between said polyamide layers possesses a layer thickness that amounts to more than 25% of the film thickness and is greater than the sum of the thicknesses of said first and second polyamide layers.

2. Film according to claim 1, wherein said sealing layer is selected from the group consisting of polyethylene and a polyethylene copolymer.

3. Film according to claim 1, wherein said bonding agent layer, which connects said sealing layer with said second polyamide layer, has a low layer thickness in comparison with said layers adjacent to said bonding agent layer.

4. Film according to claim 1, whereby the equalization layer acts as a bonding agent layer and is selected from the group consisting of an anhydride-modified polyolefin, an acid-modified polyolefin and a polyolefin copolymer having functional groups.

5. Film according to claim 4, wherein said equalization layer is selected from the group consisting of an anhydride-modified polyethylene, an acid-modified polyethylene, and a polyethylene copolymer having functional groups.

6. Film according to claim 1, wherein said equalization layer comprises three layers including a layer that is incompatible with polyamide, arranged between two bonding agent layers.

7. Film according to claim 1, wherein each of said polyamide layers have a polyamide component consisting of a member selected from the group consisting of aliphatic polyamides PA6, PA6.66, PA11, PA12, a copolymer of the monomers contained in said aliphatic polyamides, a partially aromatic polyamide, and mixtures thereof.

8. Film according to claim 1, wherein said bonding agent layer is selected from the group consisting of a polyolefin copolymer having functional groups, an anhydride-modified polyolefin, and an acid-modified polyolefin.

9. Film according to claim 8, wherein said bonding agent layer is selected from the group consisting of a polyethylene copolymer having functional groups, an anhydride-modified polyethylene, and an acid-modified polyethylene.
